(19) United States
(12) Patent Application Publication
(10) Pub. No.: US 2009/0102866 A1
(43) Pub. Date: Apr. 23, 2009

(54) LIGHTING CONTROL APPARATUS USING DIGITAL SIGMA-DELTA MODULATION

(75) Inventors: Joon Hyung LIM, Gunpo (KR); Tah Joon Park, Suwon (KR); Koon Shik Cho, Suwon (KR); Kwang Mook Lee, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 12/111,034

(22) Filed: Apr. 28, 2008

(30) Foreign Application Priority Data
Oct. 22, 2007 (KR) 10-2007-106269

(51) Int. Cl. G09G 5/10

(52) U.S. Cl. 345/690

(57) ABSTRACT

There is provided a lighting control apparatus using digital sigma-delta modulation, the apparatus including: a control part supplying a brightness control signal; a sigma-delta modulation part generating a carry signal according to the brightness control signal of the control part and a predetermined threshold signal by using a sigma-delta modulation method; and a lighting driving part generating a driving current according to the carry signal of the sigma-delta modulation part and supplying the generated driving current to a lighting part.

### CROSS-REFERENCE TO RELATED APPLICATIONS

This application claims the priority of Korean Patent Application No. 2007-0106269 filed on Oct. 22, 2007, in the Korean Intellectual Property Office, the disclosure of which is incorporated herein by reference.

### BACKGROUND OF THE INVENTION

1. Field of the Invention

The present invention relates to a lighting control apparatus, and more particularly, to a lighting control apparatus using digital sigma-delta modulation that can control brightness of an LED or the like by using a sigma-delta modulator, but not by using a PWM control function.

2. Description of the Related Art

In general, according to a lighting control method of an LED (light emitting diode) or the like, a reference brightness level is compared with a current brightness level being detected, and a driving current flowing through the LED is controlled according to a difference between the brightness levels by using pulse-width modulation (PWM).

FIG. 1 is a view illustrating a configuration of a lighting control apparatus according to the related art.

The lighting control apparatus, shown in FIG. 1, includes a main control unit 10, a PWM control unit 20, and an LED driving unit 30. The main control unit 10 performs lighting control. The PWM control unit 20 controls brightness according to a PWM method under the control of the PWM control unit 20. The LED driving unit 30 supplies a driving current to an LED unit LEDS under the control of the main control unit 10.

When the LED unit LEDS includes a plurality of LEDs LED1 to LEDn, the LED driving unit 30 includes a plurality of first to nth LED drivers that supply the driving current to the plurality of LEDs LED1 to LEDn, respectively.

The PWM control unit 20 may include a plurality of first to nth PWM controllers that control the plurality of first to nth LED drivers, respectively.

The lighting control apparatus according to the related art controls lighting of the LED unit according to the PWM method. This will be described with reference to FIG. 2.

FIG. 2 is a view illustrating a lighting control principle according to the related art.

Referring to FIG. 2, the lighting control apparatus according to the related art, shown in FIG. 1, controls lighting by varying a pulse width according to a current lighting state.

For example, when a brightness level of current lighting is higher than that of reference lighting, a pulse width is increased to reduce the brightness of the current lighting. On the other hand, when the brightness level of the current lighting is lower than that of the reference lighting, the pulse width is reduced to increase the brightness of the current lighting.

However, since the lighting control apparatus according to the related art controls lighting according to the PWM method, PWM control chips or ICs need to be additionally purchased for the PWM control.

Since the PWM control chips or ICs are expensive, this causes an increase in manufacturing costs.

### SUMMARY OF THE INVENTION

An aspect of the present invention provides a lighting control apparatus using digital sigma-delta modulation that can control brightness of LED lighting or the like by using a sigma-delta modulator, but not by using a PWM control function, to thereby reduce manufacturing costs.

According to an aspect of the present invention, there is provided a lighting control apparatus using digital sigma-delta modulation, the apparatus including: a control part supplying a brightness control signal; a sigma-delta modulation part generating a carry signal according to the brightness control signal of the control part and a predetermined threshold signal by using a sigma-delta modulation method; and a lighting driving part generating a driving current according to the carry signal of the sigma-delta modulation part and supplying the generated driving current to a lighting part.

The lighting driving part may include a plurality of first to nth lighting drivers individually supplying the driving current to a plurality of lighting devices included in the lighting part.

The sigma-delta modulation part may include a plurality of first to nth sigma-delta modulators carry signals to the first to nth lighting devices, respectively.

The lighting part may include a plurality of LEDs.

The lighting part may include a plurality of color LEDs.

Each of the first to nth sigma-delta modulators may include: an adder adding the brightness control signal of the control part and a feedback signal; a comparator comparing an output signal of the adder and the predetermined threshold signal and generating a carry signal when the output signal of the adder has a level equal to or higher than the threshold signal; a reset circuit resetting the output signal of the adder when the comparator generates the carry signal; and a feedback circuit multiplying an output signal of the reset circuit by a feedback gain to generate the feedback signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration view illustrating a lighting control apparatus according to the related art.

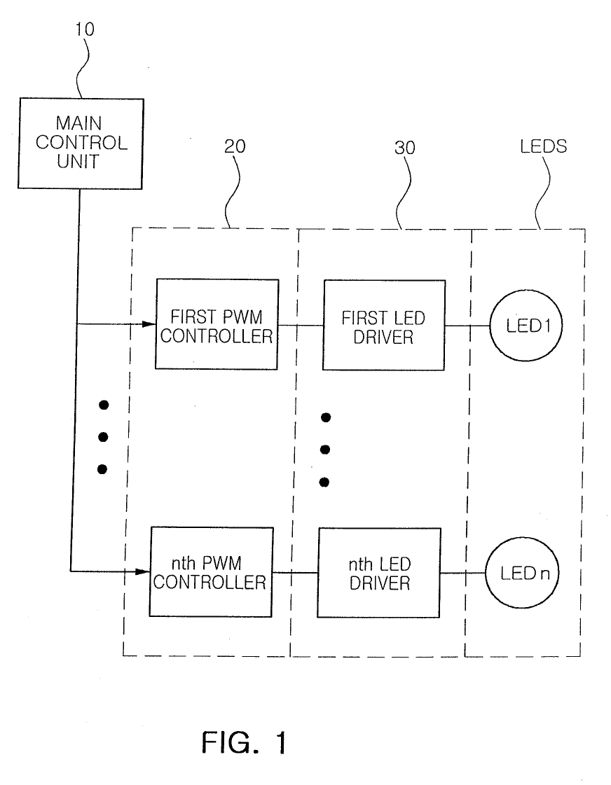

FIG. 2 is a view illustrating a lighting control principle according to the related art.

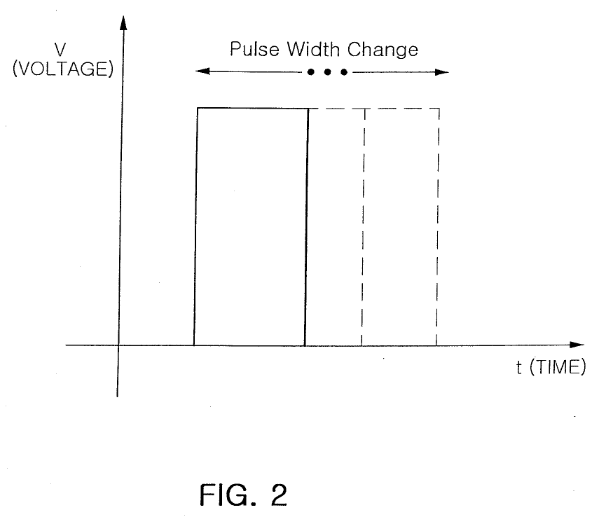

FIG. 3 is a configuration view illustrating a lighting control apparatus according to an exemplary embodiment of the present invention.

FIG. 4 is a configuration view illustrating a sigma-delta modulator according to an exemplary embodiment of the present invention.

FIG. 5 is a waveform view illustrating a voltage of an input signal and a voltage of an output signal of the sigma-delta modulator of FIG. 4.

### DETAILED DESCRIPTION OF THE PREFERRED EMBODIMENT

Exemplary embodiments of the present invention will now be described in detail with reference to the accompanying drawings.

The invention may however be embodied in many different forms and should not be construed as limited to the embodiments set forth herein. Rather, these embodiments are provided so that this disclosure will be thorough and complete, and will fully convey the scope of the invention to those skilled in the art. Also, in the drawings, the same reference numerals are used throughout to designate the same components.

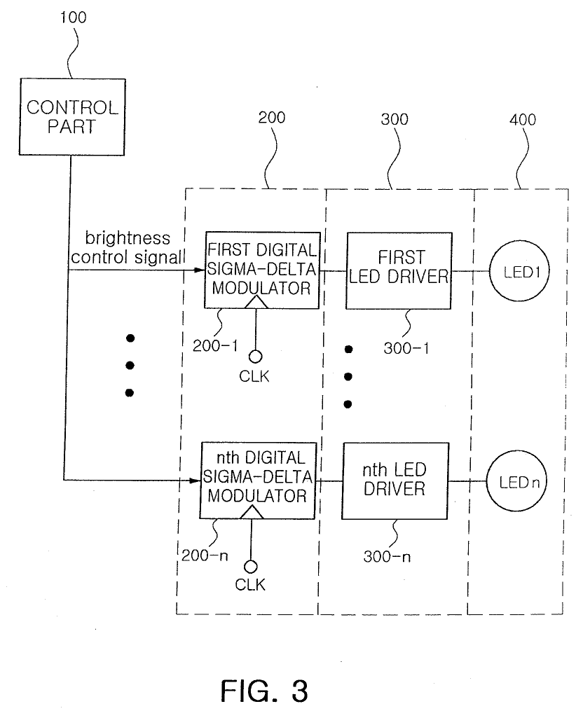

FIG. 3 is a view illustrating a configuration of a lighting control apparatus according to an exemplary embodiment of the invention.

Referring to FIG. 3, the lighting control apparatus according to the embodiment of the invention includes a control part 100, a sigma-delta modulation part 200, and a lighting driving part 300. The control part 100 supplies a brightness control signal x. The sigma-delta modulation part 200 generates a carry signal Co1 according to the brightness control signal x of the control part 100 and a predetermined threshold signal by using a sigma-delta modulation method. The lighting driving part 300 generates a driving current according to the carry signal Co1 of the sigma-delta modulation part 200 to supply the generated driving current to the lighting part 400.

The lighting driving part 300 may include a plurality of first to nth lighting drivers 300-1 to 300-n that supply the driving current to a plurality of lighting devices, respectively, which are included in the lighting part 400.

The sigma-delta modulation part 200 may include a plurality of first to nth sigma-delta modulators 200-1 to 200-n each of which supplies the carry signal Co1 to each of the plurality of first to nth lighting drivers 300-1 to 300-n.

The lighting part 400 may include a plurality of LEDs LED1 to LEDn. Alternatively, the lighting part 400 may include a plurality of color LEDs LED1 to LEDn.

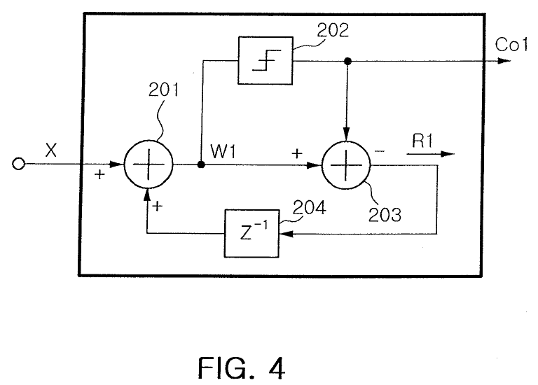

FIG. 4 is a view illustrating a configuration of a sigma-delta modulator according to an exemplary embodiment of the present invention.

Referring to FIG. 4, each of the plurality of first to nth sigma-delta modulators 200-1 to 200-n includes an adder 201 (Σ:sigma), a comparator 202, a reset circuit 203 (Δ:delta), and a feedback circuit 204. The adder 201 (Σ:sigma) adds the brightness control signal x of the control part 100 and a feedback signal R1*Z⁻¹. The comparator 202 compares an output signal W1 of the adder 201 with the predetermined threshold signal and generates the carry signal Co1 when the output signal W1 of the adder 201 has a level equal to or higher than that of the threshold signal. When the comparator 202 generates the carry signal Co1, the reset circuit 203 (Δ:delta) resets the output signal W1 of the adder 201. The feedback circuit 204 multiplies an output signal R1 of the reset circuit 203 by a feedback gain Z⁻¹ to generate the feedback signal R1*Z⁻¹.

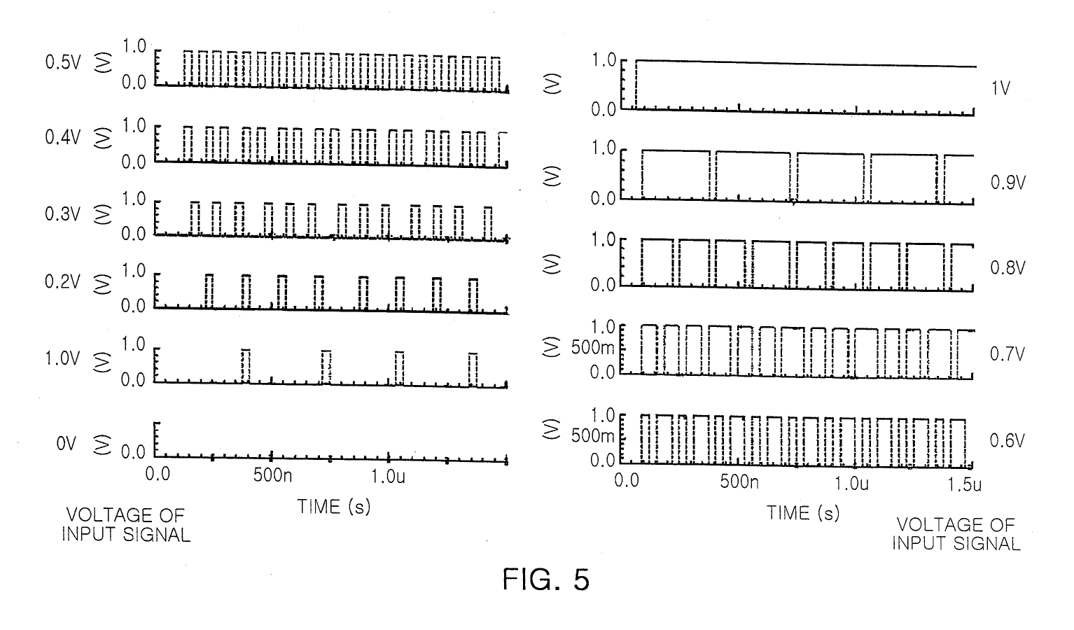

FIG. 5 is a waveform view illustrating a voltage of an input signal and a voltage of an output signal of the sigma-delta modulator of FIG. 4.

In FIG. 5, a signal waveform view shows the number of carry signals that are output for 1.5μ seconds when an input signal (=brightness control signal) corresponding to the brightness control signal x increases in voltage from 0 to 1V in intervals of 0.1V. In FIG. 5, VT means a tuning voltage according to the carry signal.

Hereinafter, the operation and effect of the invention will be described in detail with reference to the accompanying drawings.

The operation of the lighting control apparatus according to the embodiment of the invention will now be described with reference to FIGS. 3 to 5. First, in FIG. 3, the lighting control apparatus according to the embodiment of the invention includes the control part 100, the sigma-delta modulation part 200, and the lighting driving part 300.

The control part 100 supplies a brightness control signal x to the sigma-delta modulation part 200.

The sigma-delta modulation part 200 generates a carry signal Co1 according to the brightness control signal x of the control part 100 and a predetermined threshold signal by a sigma-delta modulation method to supply the generated carry signal Co1 to the lighting driving part 300.

The lighting driving part 300 generates a driving current according to the carry signal Co1 of the sigma-delta modulation part 200 and supplies the driving current to the lighting part 400.

The lighting control apparatus according to the embodiment of the invention may be applied to the lighting part 400 that includes a plurality of LEDs LED1 to LEDn.

In this case, the lighting driving part 300 may include the plurality of first to nth lighting drivers 300-1 to 300-n each of which supplies the driving current to each of the plurality of lighting devices that are included in the lighting part 400.

Further, the sigma-delta modulation part 200 may include the plurality of first to nth sigma-delta modulators 200-1 to 200-n each of which supplies the carry signal Co1 to each of the plurality of first to nth lighting drivers 300-1 to 300-n.

Alternatively, the lighting part 400 may include a plurality of color LEDs LED1 to LEDn.

Referring to FIGS. 3 and 4, each of the plurality of first to nth sigma-delta modulators 200-1 to 200-n may include the adder 201, the comparator 202, the reset circuit 203, and the feedback circuit 204.

In this case, the adder 201 adds the brightness control signal x of the control part 100 and a feedback signal R1*Z⁻¹ and outputs an output signal W1 to the comparator 202 and the reset circuit 203.

The comparator 202 compares the output signal W1 of the adder 201 with the predetermined threshold signal. When the output signal W1 of the adder 201 has a level equal to or higher than the threshold signal, the comparator 202 generates the carry signal Co1 and outputs the carry signal Co1 to the lighting driving part 300.

Further, the reset circuit 203 resets the output signal W1 of the adder 201 when the comparator 202 generates the carry signal Co1.

Further, the feedback circuit 204 multiples an output signal R1 of the reset circuit 203 by a feedback gain Z⁻¹ to generate the feedback signal R1*Z⁻¹ and supplies the generated feedback signal R1*Z⁻¹ to the adder 201.

The above-described sigma-delta modulator is one of basic modulators, such as an analog-digital converter and a digital-analog converter, in the electronics field. The configuration and the operation of the sigma-delta modulator according to one embodiment of the invention will be described with reference to the following equations and the drawings.

The operation of each of the sigma-delta modulators 200-1 to 200-n according to the embodiment of the invention will be described by using the following Equations.

First, the output signal W1(Z) of the adder 201, the carry signal Co1(Z) of the comparator 202, and the output signal R1(Z) of the reset circuit 203 may be shown as Equations 1, 2, and 3 as follows.

W1(Z)=X(Z)+R1(Z)*Z⁻¹ [Equation 1]

W1(Z)+E1(Z)=Co1 [Equation 2]

R1(Z)=W1(Z)−Co1 [Equation 3]

Here, E1(Z) is an error factor of the comparator 202.

R1(Z) in Equation 3 is substituted into R1(Z) in Equation 1 to thereby obtain Equations 4, 5, and 6 as follows.

W1(Z)=X(Z)+(W1(X)−Co1)*Z⁻¹ [Equation 4]

W1(Z)−W1(Z)*Z⁻¹=X(Z)−Co1*Z⁻¹ [Equation 5t]

W1(Z)(1−Z⁻¹)=X(Z)−Co1*Z⁻¹ [Equation 6]

W1(Z) in Equation 2 is substituted into Equation 6 to obtain Equations 7 and 8 as follows.

(Co1−E1(Z))(1−Z⁻¹)=X(Z)−Co1*Z⁻¹ [Equation 7]

Co1(1−Z⁻¹)=X(Z)−Co1*Z⁻¹+E1(Z))(1−Z⁻¹) [Equation 8]

In Equation 8, ‘Co1*Z−1’ is calculated to obtain Equation 9 as follows.

$$Co 1 ( 1 - {Z}^{- 1} ) + Co 1 * {Z}^{- 1} = X ( Z ) + E 1 ( Z ) ) ( 1 - {Z}^{- 1} ) \\ Co 1 - Co 1 * {Z}^{- 1} + Co 1 * {Z}^{- 1} = X ( Z ) + E 1 ( Z ) ) ( 1 - {Z}^{- 1} ) \\ Co 1 = X ( Z ) + E 1 ( Z ) ) ( 1 - {Z}^{- 1} ) \qquad [ Equation 9 ]$$

In Equation 9, since ‘(1−Z⁻¹)’ corresponds to a high pass filter (NTF), noise in an input signal band is reduced so that the carry signal can be efficiently generated.

When Equation 6 is calculated, Equation 10 may be induced as follows.

$$W 1 ( Z ) = \frac{X ( Z ) - Co 1 * {Z}^{- 1}}{( 1 - {Z}^{- 1} )} \qquad [ Equation 10 ]$$

Here, Equation 10 is substituted into Equation 3 to obtain Equation 11 as follows.

$$\begin{matrix}R 1 ( Z ) = \frac{X ( Z ) - Co 1 * {Z}^{- 1}}{( 1 - {Z}^{- 1} )} - \frac{( 1 - {Z}^{- 1} )}{( 1 - {Z}^{- 1} )} Co 1 \\ = \frac{X ( Z ) - Co 1 * {Z}^{- 1} - Co 1 + Co 1 * {Z}^{- 1}}{( 1 - {Z}^{- 1} )} \\ = \frac{X ( Z ) - Co 1}{( 1 - {Z}^{- 1} )}\end{matrix} \qquad [ Equation 11 ]$$

In Equation 11, since ‘1/(1−z⁻¹)’ corresponds to a low pass filter (STF), an output signal obtained by passing the input signal through the sigma-delta modulator practically passes the low pass filter.

The above Equation 9 shows that a noise transfer function (NTF) of the sigma delta modulator has high pass filter characteristics. The above Equation 11 shows that transfer function characteristics of the sigma-delta modulator with respect to the input signal has low pass filter characteristics.

For example, the operation of each of the plurality of first to nth sigma-delta modulators 200-1 to 200-n of the sigma-delta modulation part 200 according to the embodiment of the invention will be described with reference to the following Table 1.

TABLE 1

| | CLK | | | | | | | | | | |
|---|---|---|---|---|---|---|---|---|---|---|---|
| | 0 | 1 | 2 | 3 | 4 | 5 | 6 | 7 | 8 | 9 | 10 |
| X | 4 | 4 | 4 | 4 | 4 | 4 | 4 | 4 | 4 | 4 | 4 |
| W1 | 4 | 8 | 12 | 0 | 4 | 8 | 12 | 0 | 4 | 8 | 12 |
| R1 * Z⁻¹ | 0 | 4 | 8 | 12 | 0 | 4 | 8 | 12 | 0 | 4 | 8 |
| Col | 0 | 0 | 0 | 1 | 0 | 0 | 0 | 1 | 0 | 0 | 0 |

Referring to Table 1, each of the plurality of first to nth sigma-delta modulators 200-1 to 200-n of the sigma-delta modulation part 200 operates according to a clock signal CLK. When the brightness control signal x of the control part 100, that is, the input signal has a voltage of 4, and the threshold signal has a voltage of 12, each of the plurality of first to nth sigma-delta modulators 200-1 to 200-n of the sigma-delta modulation part 200, as shown in Table 1, generates the carry signal Co1 if the output signal W1(Z) has a level equal to or higher than the threshold signal.

When the brightness control signal x, that is, the input signal, has a voltage of more than 4, the number of carry signals generated is higher than the number shown in Table 1. On the other hand, when the brightness control signal x has a voltage of less than 4, the number of carry signals generated is lower than the number shown in Table 1.

For example, when the current driving voltage is smaller than predetermined current, the level of the brightness control signal x is increased to increase the number of carry signals generated. Further, the tuning voltage is increased according to the number of carry signals generated, and thus, the control can be adjusted so that the driving current of the tuning voltage is increased.

On the other hand, when the current driving current is larger than the predetermined current, the level of the brightness control signal x is reduced to reduce the number of carry signals generated. The control can be adjusted so that the driving current is reduced.

FIG. 5 is a signal waveform view illustrating the number of carry signals that are output for 1.5μ seconds when the input voltage corresponding to the brightness control signal x increases 0 to 1V in intervals of 0.1V.

Referring to FIG. 5, the number of carry signals generated can vary according to a change in the brightness control signal X, and thus, the driving current can be controlled.

As described above, as compared to the method according to the related art, the main control unit (MCU) operates the digital sigma-delta modulators (DSM) to control the LED drivers, so that brightness of the LED lighting and the on/off operation thereof can be controlled.

Since the DSMs (Digital Sigma-delta Modulators) are used, and outputs thereof are used to control the LED drivers, digital noise shaping is possible, and fine and accurate control of brightness can be obtained.

According to the embodiment of the invention, even though a PWM controller is not used, LED lighting can be efficiently controlled by using the main control unit (MCU) and the digital sigma-delta modulators. Noise can be reduced by using the sigma-delta modulators for controlling the LED drivers. Further, desired lighting colors can be produced using three primary colors by controlling brightness according to combinations of color LEDs.

As set forth above, according to an exemplary embodiment of the invention, since the brightness of lighting of an LED or the like can be controlled by using the sigma-delta modulators without using the PWM control function, the expensive PWM controllers can be replaced with the sigma-delta modulators, which results in a reduction in manufacturing costs.

While the present invention has been shown and described in connection with the exemplary embodiments, it will be apparent to those skilled in the art that modifications and variations can be made without departing from the spirit and scope of the invention as defined by the appended claims.

What is claimed is:

1. A lighting control apparatus using digital sigma-delta modulation, the apparatus comprising:
a control part supplying a brightness control signal;
a sigma-delta modulation part generating a carry signal according to the brightness control signal of the control part and a predetermined threshold signal by using a sigma-delta modulation method; and
a lighting driving part generating a driving current according to the carry signal of the sigma-delta modulation part and supplying the generated driving current to a lighting part.

2. The lighting control apparatus of claim 1, wherein the lighting driving part comprises a plurality of first to nth lighting drivers individually supplying the driving current to a plurality of lighting devices included in the lighting part.

3. The lighting control apparatus of claim 1, wherein the sigma-delta modulation part comprises a plurality of first to nth sigma-delta modulators carry signals to the first to nth lighting devices, respectively.

4. The lighting control apparatus of claim 1, wherein the lighting part comprises a plurality of LEDs.

5. The lighting control apparatus of claim 1, wherein the lighting part comprises a plurality of color LEDs.

6. The lighting control apparatus of claim 3, wherein each of the first to nth sigma-delta modulators comprises:
an adder adding the brightness control signal of the control part and a feedback signal;
a comparator comparing an output signal of the adder and the predetermined threshold signal and generating a carry signal when the output signal of the adder has a level equal to or higher than the threshold signal;
a reset circuit resetting the output signal of the adder when the comparator generates the carry signal; and
a feedback circuit multiplying an output signal of the reset circuit by a feedback gain to generate the feedback signal.
